(19) United States
(12) Patent Application Publication
(10) Pub. No.: US 2025/0345937 A1
(43) Pub. Date: Nov. 13, 2025

(54) LEARNING APPARATUS

(71) Applicant: TOYOTA JIDOSHA KABUSHIKI KAISHA, Aichi-ken (JP)

(72) Inventors: Tianyi TESHIMA, Tokyo-to (JP); Takuya IKEDA, Tokyo-to (JP)

(73) Assignee: TOYOTA JIDOSHA KABUSHIKI KAISHA, Aichi-ken (JP)

(21) Appl. No.: 19/180,130

(22) Filed: Apr. 16, 2025

(30) Foreign Application Priority Data
May 8, 2024 (JP) 2024-075615

(51) Int. Cl. B25J 9/16; G05B 13/02

(52) U.S. Cl. CPC B25J 9/1671; G05B 13/0265

(57) ABSTRACT

To realize a learning apparatus which improves the estimation accuracy of a grasping posture of a robot hand having symmetry. A learning apparatus according to one embodiment of the present disclosure includes a learning unit configured to learn, by machine learning, a posture for grasping an object by a robot hand, the machine learning being performed using training data represented by one parameter set which includes a first posture of the robot hand having a 2-fold rotational symmetry property and a second posture of the robot hand rotated 180° around an axis of rotational symmetry of the first posture.

### CROSS REFERENCE TO RELATED APPLICATIONS

This application is based upon and claims the benefit of priority from Japanese patent application No. 2024-075615, filed on May 8, 2024, the disclosure of which is incorporated herein in its entirety by reference.

### BACKGROUND

The present disclosure relates to a learning apparatus.

Patent Literature 1 describes a grasping apparatus that grasps an object using a robot hand having symmetry.

Patent Literature 1: Japanese Unexamined Patent Application Publication No. 2018-089752

### SUMMARY

In performing machine learning of a grasping posture of a robot hand (e.g., two-finger hand) having rotational symmetry, the symmetry may destabilize machine learning and reduce estimation accuracy. For example, in the case where a grasping posture of 0° rotation is output in one region and a grasping posture of 180° rotation is output in another region, an incorrect grasping posture may be output at the interface between the two regions.

The present disclosure has been made in view of such problems, and it is an object of the present disclosure to provide a learning apparatus that improves the estimation accuracy of a grasping posture of a robot hand having symmetry.

A learning apparatus according to the present disclosure includes a learning unit configured to learn, by machine learning, a posture for grasping an object by a robot hand, the machine learning being performed using training data representing a first posture of the robot hand having a 2-fold rotational symmetry property and a second posture obtained by rotating the first posture by 180° around an axis of rotational symmetry by one parameter set.

According to the present disclosure, it is possible to provide a learning apparatus that can improve the estimation accuracy of a grasping posture of a robot hand having symmetry.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a grasping system according to a first embodiment;

FIG. 2 is a diagram showing an example of a configuration of a robot hand according to the first embodiment;

FIG. 3A is a diagram for explaining a method of expressing a posture of the robot hand according to the first embodiment;

FIG. 3B is a diagram for explaining a method of expressing a posture of the robot hand according to the first embodiment;

FIG. 3C is a diagram for explaining a method of expressing a posture of the robot hand according to the first embodiment;

FIG. 3D is a diagram for explaining a method of expressing a posture of the robot hand according to the first embodiment; and

FIG. 3E is a diagram for explaining a method of expressing a posture of the robot hand according to the first embodiment.

### DESCRIPTION OF EMBODIMENTS

Specific embodiments to which the present disclosure is applied will be described in detail below with reference to the drawings. However, the present disclosure is not limited to the following embodiments. In order to clarify the explanation, the following descriptions and drawings are simplified as appropriate.

### First Embodiment

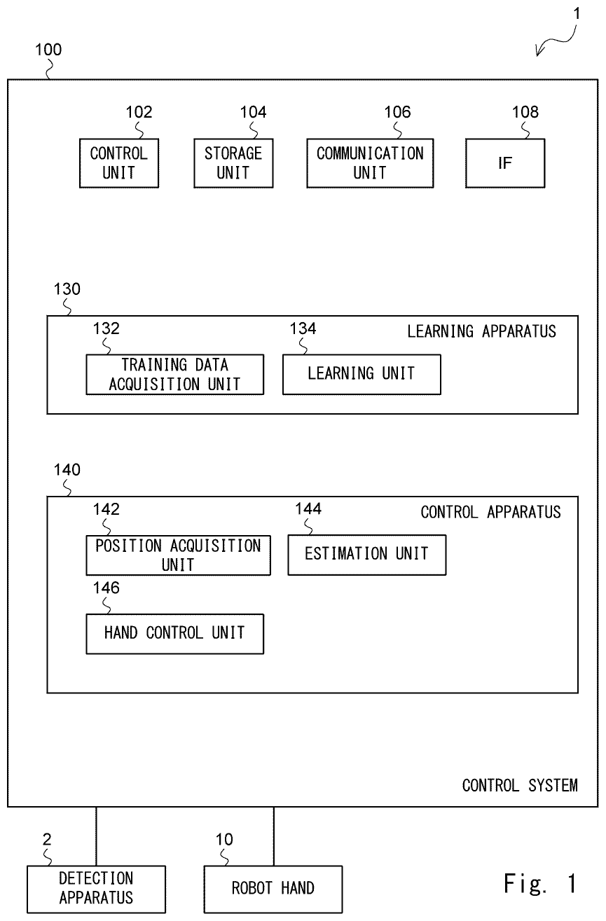

FIG. 1 is a block diagram showing the configuration of a grasping system 1 according to a first embodiment. The grasping system 1 includes a detection apparatus 2, a robot hand 10, and a control system 100. The control system 100 is connected to the detection apparatus 2 and the robot hand 10 via a wireless or wired communication network.

The grasping system 1 estimates a grasping posture of a robot hand using an inference model generated in advance through machine learning. The grasping system 1 grasps an object by taking an estimated grasping posture. Here, training for learning an inference model can be performed, for example, by a neural network.

The detection apparatus 2 detects each position (i.e., coordinates) of an object located in a three-dimensional space. In other words, the detection apparatus 2 detects (captures, measures) the position of an object located in a three-dimensional space. The detection apparatus 2 detects whether or not an object exists at each position in the three-dimensional space. The detection apparatus 2 may be, but is not limited to, a three-dimensional camera such as an RGB-D camera or a stereo camera, a depth camera, or LiDAR (Light Detection And Ranging). In the first embodiment, the position of an object in the three-dimensional space is expressed by voxels, but is not limited thereto.

The robot hand 10 is configured to grasp an object located in a three-dimensional space. The operation of the robot hand 10 is controlled by the control system 100. That is, the robot hand 10 grasps an object under the control of the control system 100. The robot hand 10 may be an end effector provided at the tip of a robot arm (not shown).

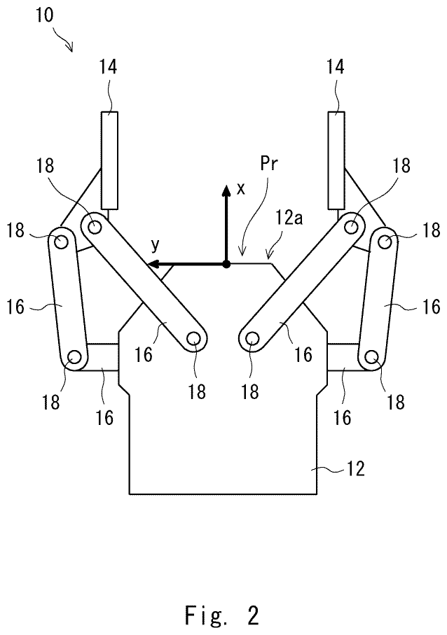

FIG. 2 is a diagram illustrating the robot hand 10. The robot hand 10 includes a hand main body 12, two finger parts 14, a plurality of links 16, and a plurality of joint parts 18. The finger parts 14 are connected to the hand main body 12 via the plurality of links 16 and the plurality of joint parts 18. The finger parts 14 are operated by driving at least one joint part 18. Here, a part of the joint parts 18 among the plurality of joint parts 18 may be driven. A driving apparatus such as a motor is incorporated in the joint parts 18 which are drivable. The robot hand 10 can take a grasping posture of six degrees of freedom in a three-dimensional space.

Here, a reference point Pr is set in the robot hand 10. The reference point Pr is also referred to as TCP (Tool Center Point). The reference point Pr is the origin of the hand coordinate system (x, y, z). The (x-positive) direction is the direction in which the robot hand 10 approaches an object. The y-direction is the direction along which the finger parts 14 are operated (opened and closed). The z-direction, which is the direction perpendicular to the xy plane, is the direction of normal vector of the plane in which the finger parts 14 are operated. The reference point Pr can be arbitrarily determined. In the example of FIG. 2, the reference point Pr is provided near the center of a front surface 12a of the hand main body 12 in the y-direction, but it is not limited thereto. The reference point Pr may be located outside the hand main body 12 or inside the hand main body 12.

The robot hand 10 has a 2-fold rotational symmetry property with respect to an axis of rotational symmetry, the x-axis being the axis of rotational symmetry. The robot hand 10 has a plane symmetry with respect to a symmetric plane (e.g., xy-plane, xz-plane) including the axis of rotational symmetry.

Referring again to FIG. 1, the control system 100 is, for example, a computer such as a server. The control system 100 may be implemented by, for example, cloud computing. The control system 100 may be implemented by a plurality of computers. In this case, the plurality of components of the control system 100 to be described later may be implemented by physically different computers.

The control system 100 includes a control unit 102, a storage unit 104, a communication unit 106, and an interface unit 108 (IF Interface) as a main hardware configuration. The control unit 102, the storage unit 104, the communication unit 106, and the interface unit 108 are mutually connected via a data bus or the like. In the case where the control system 100 is implemented by a plurality of computers, each of the plurality of computers may have the hardware configuration shown in FIG. 1.

The control unit 102 is a processor such as a CPU (Central Processing Unit), for example. The control unit 102 has a function as an arithmetic unit that performs control processing, arithmetic processing, and the like. The control unit 102 may have a plurality of processors. The storage unit 104 is a storage device such as a memory or a hard disk, for example. The storage unit 104 is a ROM (Read Only Memory) or RAM (Random Access Memory), for example. The storage unit 104 has a function for storing control programs and arithmetic programs executed by the control unit 102. That is, the storage unit 104 (memory) stores one or more instructions. The storage unit 104 also has a function for transitory storing processing data and the like. The storage unit 104 may include a database. The storage unit 104 may have a plurality of memories.

The communication unit 106 performs processing necessary for communicating with other devices via a network. The communication unit 106 may include a communication port, a router, a firewall, etc. The interface unit 108 is, for example, a user interface (UI). The interface unit 108 includes an input device such as a keyboard, a touch panel, or a mouse, and an output device such as a display or a speaker. The interface unit 108 may be configured such that the input device and the output device are integrated, like a touch panel, for example. The interface unit 108 accepts a data input operation by a user, and outputs information to the user.

The control system 100 includes a learning apparatus 130 and a control apparatus 140. The learning apparatus 130 and the control apparatus 140 may be physically separate apparatuses. In this case, each of the learning apparatus 130 and the control apparatus 140 has the above-described hardware configuration. The learning apparatus 130 and the control apparatus 140 may be physically the same apparatus. For example, the functions of the control apparatus 140 may be incorporated into the learning apparatus 130.

The learning apparatus 130 includes a training data acquisition unit 132 and a learning unit 134 as components. The control apparatus 140 includes a position acquisition unit 142, an estimation unit 144, and a hand control unit 146 as components.

The above-described components can be realized by executing a program under the control of the control unit 102, for example. More specifically, the components can be realized by the control unit 102 executing a program (instructions) stored in the storage unit 104. Further, the components can be realized by recording a necessary program in an optional nonvolatile storage medium and installing the program as needed. Further, each component may be realized not only by software but may be realized by any combination of hardware, firmware, and software. Further, each component may be realized by using a user-programmable integrated circuit such as an FPGA (field-programmable gate array) or a microcomputer. In this case, the integrated circuit may be used to realize a program configured of the above-described components.

The training data acquisition unit 132 generates training data to be used for generating an inference model. The training data acquisition unit 132 generates training data showing a grasping posture in the case where, for example, there is the reference point Pr of the robot hand 10 at each position in the three-dimensional space where the object is located. The training data acquisition unit 132 acquires, for example, opposing points on the surface of the object, and can determine the grasping posture of the robot hand 10 so that the opposing points become contact points of the finger parts 14. The training data acquisition unit 132 may determine the grasping posture that does not allow the grasped object drop in consideration of gravity.

The training data acquisition unit 132 generates training data by using the position of the reference point Pr in each grasping posture and posture data indicating the grasping posture. Here, in realizing the corresponding grasping posture, the posture data is a parameter set including parameters related to a unit vector in the direction in which the robot hand 10 approaches the object (the direction in which the x-direction in FIG. 2 is projected in the three-dimensional space) and parameters related to the normal vector in the plane in which the finger parts 14 move (the plane in which the xy plane in FIG. 2 is projected in the three-dimensional space). It should be noted that a parameter set may include parameters related to the normal vector of the plane in the case where the xz plane of FIG. 2 is projected in the three-dimensional space instead of the parameters related to the normal vector of the plane in the case where the xy plane of FIG. 2 is projected in the three-dimensional space.

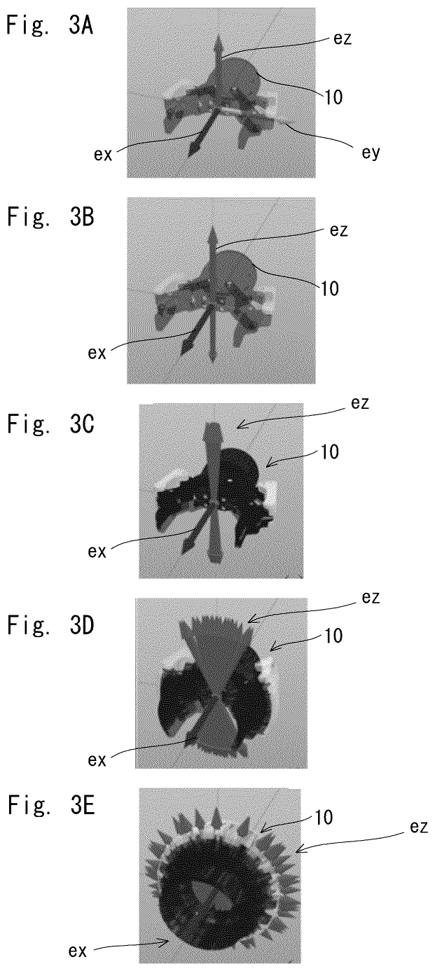

Referring to FIG. 3A to 3E, a method of expressing posture data according to the first embodiment will be described. Referring to FIG. 3A, the posture of the robot hand 10 is represented by a rotation matrix in which three mutually perpendicular vectors ex, ey, and ez are arranged. The vector ex is a unit vector in the direction in which the robot hand 10 approaches the object (the direction parallel to the axis of rotational symmetry). The vector ez (normal vector ez) is a unit vector perpendicular to a plane on which the finger parts 14 move, that is, one of the symmetric planes of the robot hand 10. When the vectors ex and the normal vector ez are determined, ey is also determined, whereby the posture of the robot hand 10 is determined.

Conventionally, posture data including the vectors ex and the normal vector ez have been used. However, posture data representing one posture of the robot hand 10 and posture data representing a posture, in which the posture of the robot hand is rotated 180° around the axis of rotational symmetry, are different from each other, and there has been concerns that the estimation accuracy of grasping posture may be lowered.

Referring to FIG. 3B, it is assumed that the training data acquisition unit 132 and the vector ez are symmetrically distributed with respect to the above-mentioned symmetric plane, and the parameter set including the parameters of the aforementioned distribution and the vector ex is referred to as posture data. Thus, one posture of the robot hand 10 and a posture in which the aforementioned one posture is rotated 180° about the axis of rotational symmetry are expressed by one parameter set.

As the distribution of the normal vector ez, a distribution (e.g., two-dimensional Bingham distribution) defined on a sphere and symmetric with respect to a symmetric plane (the plane on which the finger parts 14 move) may be used. The two-dimensional Bingham distribution is represented by, for example, six parameters which are elements of a third-order symmetric matrix. The peak of the distribution and the shape of the distribution are determined by the six parameters.

By using a distribution such as the two-dimensional Bingham distribution, information on reliability of the estimated posture data can also be obtained. For example, in the case where variation of the distribution is large, reliability may be determined to be low. FIG. 3C shows a plurality of postures represented by highly reliable posture data. A plurality of vectors ez randomly selected from the distribution are substantially identical, and show substantially identical postures. FIG. 3D shows a plurality of postures represented by the posture data with low reliability. On the other hand, in the case where a cylindrical object is grasped from its end, the robot hand 10 can sandwich the object from any direction. In this case, as shown in FIG. 3E, the distribution of the normal vector ez is uniform.

Referring again to FIG. 1, for example, the training data acquisition unit 132 generates a TSDF volume for each voxel from a depth image obtained by photographing (rendering) a scene in which an object is located in a three-dimensional space (e.g., a virtual space) from a predetermined direction, and uses the TSDF volume as input data in the training data. The TSDF volume indicates the distance from each voxel in the three-dimensional space to an object nearest to the respective voxels.

For example, the training data acquisition unit 132 uses posture data in the case where there is a reference point Pr of the robot hand 10 at each position of the input data as output data in the training data. The training data acquisition unit 132 can, for example, select a grasping posture of the case where the reference point Pr of the robot hand 10 is at each position, and calculate the parameters of the two-dimensional Bingham distribution using the normal vector ez of the grasping posture and an appropriate loss function.

The output data in the training data may further include a score and a mask value with the reference point Pr of the robot hand 10 at each voxel. The mask value indicates a value representing “true” (e.g., “1”) when an object can be grasped (that is, there is a grasping posture) in the case where the reference point Pr is at each position (voxel) in the three-dimensional space. On the other hand, the mask value indicates “false” (e.g., “0”) when an object cannot be grasped (that is, there is no grasping posture) in the case where the reference point Pr is at that position. In the output data, the score represents the quality of grasping in the case where the reference point Pr is in the three-dimensional space. The higher the quality of the grasping, the more firmly the robot hand 10 can grasp the object.

The training data is not limited to the example described above. The position in the three-dimensional space may be expressed not by voxels but by point cloud data. In the above example, posture data in the case where the reference position Pr is at each position of the input data is calculated, but any known technique may be used as a method for determining posture data for the input data. For example, a grasping posture may be determined using the position of an object shown in the point cloud data as a contact point.

By executing machine learning, the learning unit 134 learns an inference model so as to input the input data in the training data and output the output data in the training data. Thus, the learning unit 134 generates the trained inference model. The inference model may be implemented by a neural network such as, for example, a Fully Convolutional Network (FCN), but is not limited to this.

The input of the neural network may be, for example, voxel data (TSDF volume) of a scene in which a plurality of objects with dimensions of 40×40×40 may be included. In this case, the output of the neural network may be, for example, a score with dimensions of 40×40×40, a mask value with dimensions of 40×40×40, and posture data with dimensions of 40×40×40×9. Posture data may include, for example, a three-dimensional vector ex and six elements of a third-order symmetric matrix representing a two-dimensional Bingham distribution. The score, mask value, and posture data are output for each of the plurality of voxels.

The control apparatus 140 controls the robot hand 10 so as to grasp an object arranged in the three-dimensional space. The position acquisition unit 142 acquires the TSDF volume or point cloud data for each voxel in the three-dimensional space based on the detection result by the detection apparatus 2.

The estimation unit 144 estimates posture data of the robot hand 10 using an inference model. The estimation unit 144 may input the TSDF volume acquired by the position acquisition unit 142 to an inference model and acquire posture data output from the inference model.

The estimation unit 144 may determine one or more normal vector ez based on the distribution of the normal vector ez. The estimation unit 144 may determine the normal vector ez corresponding to the peak of the distribution and may perform sampling of the normal vector ez from the distribution. Then, the estimation unit 144 may estimate a grasping posture based on the determined normal vector ez and the unit vector ex included in the posture data.

The estimation unit 144 may determine whether the reliability of the estimated posture data is high or not from the variations in the distribution of the normal vector ez. The estimation unit 144 may output, to the hand control unit 146, a grasping posture based on posture data whose reliability is higher than the predetermined value.

The estimation unit 144 may perform sampling of a plurality of the normal vectors ez from the distribution of the normal vector ez and estimate a plurality of grasping postures corresponding to the plurality of the normal vectors ez. This is useful in considering other constraints such as arrangement and collision avoidance.

The hand control unit 146 controls the robot hand 10 based on the determined grasping posture. The hand control unit 146 may reproduce posture of the robot hand 10 using a rotation matrix obtained according to the estimated grasping posture, for example, by locating a reference point Pr at the voxel where the grasping posture is determined.

In a learning apparatus according to the first embodiment, the estimation accuracy of a grasping posture of a robot hand can be improved by expressing the two postures of a robot hand having symmetry as one parameter set.

The program includes instructions (or software code) for causing the computer to perform one or more functions described in example embodiment when read into the computer. The program may be stored in a non-transitory computer-readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

It should be noted that present disclosure is not limited to the above embodiments and may be changed as appropriate to the extent that it does not deviate from the gist of the present disclosure. For example, in the embodiments described above, a grasping posture is expressed by three orthogonal unit vectors, but a grasping posture may be expressed in other ways.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A learning apparatus comprising a learning unit configured to learn, by machine learning, a posture for grasping an object by a robot hand, the machine learning being performed using training data representing a first posture of the robot hand having a 2-fold rotational symmetry property and a second posture obtained by rotating the first posture by 180° around an axis of rotational symmetry by one parameter set.

2. The learning apparatus according to claim 1, wherein
the robot hand has a plane symmetry with respect to a symmetric plane including the axis of rotational symmetry,
the parameter set includes parameters of a distribution of a normal vector that is perpendicular to the symmetric plane and parameters representing a vector parallel to the axis of rotational symmetry.

3. The learning apparatus according to claim 2, wherein the distribution is defined on a sphere and is symmetric with respect to the symmetric plane.

4. The learning apparatus according to claim 3, further comprising an estimation unit configured to perform estimation of a parameter set representing a posture for grasping the object by the robot hand using an inference model generated by the learning unit and then determine whether reliability of the parameter set is high or not from variations in the distribution based on the parameter set.

5. The learning apparatus according to claim 3, further comprising an estimation unit configured to perform estimation of a parameter set representing a posture for grasping the object by the robot hand using an inference model generated by the learning unit and then perform sampling of a plurality of normal vectors from the distribution based on the parameter set to thereby perform estimation of a plurality of postures corresponding to the plurality of normal vectors, respectively.
